(19) United States
(12) Patent Application Publication
(10) Pub. No.: US 2009/0293101 A1
(43) Pub. Date: Nov. 26, 2009

(54) INTEROPERABLE RIGHTS MANAGEMENT

(76) Inventors: Stephen R. Carter, Spanish Fork, UT (US); Tammy Anita Green, Provo, UT (US)

Correspondence Address: SCHWEGMAN, LUNDBERG & WOESSNER/NOVELL, PO BOX 2938, MINNEAPOLIS, MN, 55402, US

(21) Appl. No.: 12/210,930

(22) Filed: Sep. 15, 2008

Related U.S. Application Data
(60) Provisional application No. 61/054,948, filed on May 21, 2008.

(51) Int. Cl. G06F 21/00

(52) U.S. Cl. 726/1

(57) ABSTRACT

Techniques for interoperable rights management are provided. Content is packaged with declarations defining access rights. The packaged content is delivered to a target resource in accordance with a distribution policy. When the content is accessed the access rights are enforced against the target resource within the target environment in accordance with a local access policy.

### RELATED APPLICATIONS

The present application is: a non-provisional application of; is co-pending with; and claims priority to, the provisional filing having Ser. No. 61/054,948 entitled “Interoperable Rights Management,” and filed on May 21, 2008; the disclosure of which is incorporated by reference herein and below.

### BACKGROUND

The collaborative nature of today's modem business world makes it increasingly difficult to assure that policy governing content can be enforced. As content traverses identity and policy boundaries over a network, the assurance that privacy and confidentiality restrictions are being observed becomes very hard to assert. One of the reasons for this difficulty is the disassociation of rights declarations from the documents that the rights pertain to. Another difficulty is that even if a declaration of the rights and restrictions attendant to the use of content is associated with the content, consistent policy interpretation across identity and policy boundaries can not be guaranteed.

As a result, enterprises have developed a variety of proprietary solutions that include specialized data formats requiring specialized viewers and editors. Some companies have gone so far as to create specialized hardware in an attempt to control how their content is distributed and accessed. Entire industries have emerged in an effort to break some of these content formats. This has been particular true with data formats associated with Apple's iTunes®.

Suffice it to say that enterprises do not have cost effective and widely deployable solutions to control their content once it is released on the Internet via an email or a World-Wide Web (WWW) posting. In fact, once the content is acquired in electronic format it becomes susceptible to malfeasance and/or misfeasance on the part of the user that possess that content.

Accordingly, improved techniques for controlling access to content are needed.

### SUMMARY

In various embodiments, techniques for interoperable rights management are presented. More specifically, and in an embodiment, a method for interoperable rights management is provided. Access rights are assigned to content; the access rights are defined as declarations. Next, the content is encoded with the declarations to create modified content. Finally, the modified content is transported to a target environment in accordance with a content distribution policy. The modified content is subsequently decoded in the target environment and access to the content from that target environment is constrained by the declarations.

### BRIEF DESCRIPTION OF THE DRAWINGS

FIG. 1 is a diagram of a method for interoperable rights management, according to an example embodiment.

FIG. 2 is a diagram of another method for interoperable rights management, according to an example embodiment.

FIG. 3 is a diagram of an interoperable rights management system, according to an example embodiment.

FIG. 4 is a diagram of another interoperable rights management system, according to an example embodiment.

### DETAILED DESCRIPTION

A “resource” includes a service, system, device, directory, data store, user, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from one or more identifiers, secrets, and/or attributes that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc. As more and more identifiers are accumulated, a confidence in a particular identity grows stronger and stronger. In an embodiment, the identifier is a signature or a pair of signatures. For example, the signature of an identity service that vouches for a crafted identity, the signature of a principal associated with the crafted identity, or the signature of both the identity service and the principal.

“Authentication” is the process of validating the association of identifiers and secrets according to a policy, which is specific to the context in which the resulting identity is to be used. Thus, when identifiers are validated within a context specific to how an identity is to be used, it is authentication.

A “crafted identity” is an identity that may permit a principal's true identity to remain anonymous from the resource it seeks to access. With a crafted identity, an identity vault (e.g., one or more repositories holding secrets and identifiers) is opened to create the crafted identity and authenticate the principal to which it is associated, and then the identity vault is closed. Thereafter, the crafted identity can be validated by a resource, and acted upon without ever re-referencing the identity vault.

Example creation, maintenance, and use of crafted identities are discussed in U.S. patent Ser. No. 11/225,993 (“Crafted Identities”); commonly assigned to Novell, Inc. of Provo, Utah and the disclosure of which is incorporated by reference herein.

A “semantic identity” is a special type of identity that the agent can assume. Automated resources, such as services, may process the semantic identity over a network on behalf of the agent to which the semantic identity is associated. The semantic identity is confined or circumscribed to defined categories and interests identified by the agent. That is, the services that process the semantic identity over a network operate within a circumscribed semantic space of that network, where the semantic space is defined by the categories and the interests of the semantic identity.

Example creation, maintenance, and use of semantic identities are discussed in U.S. patent Ser. No. 11/261,972 (“Semantic Identities”), commonly assigned to Novell, Inc. of Provo, Utah and the disclosure of which is incorporated by reference herein.

An “attested identity” is a collection of attributes, roles, rights, privileges, and assertions; the validity of which is attested to by attesting resources according to stated policy. The activation of an attested identity involves the application of policy and testing of assertions, such that access to a resource is allowed, denied, partially allowed, or restricted in some manner.

Example creation, maintenance, and use of attested identities are discussed in U.S. patent Ser. No. 11/225,994 (“Attested Identities”), commonly assigned to Novell, Inc. of Provo, Utah and the disclosure of which is incorporated by reference herein.

In some embodiments, an identity service is used. Examples of an identity service can be found in: U.S. patent Ser. Nos. 10/765,523 (“Techniques for Dynamically Establishing and Managing Authentication and Trust Relationships”), 10/767,884 (“Techniques for Establishing and Managing a Distributed Credential Store”), and 10/770,677 (“Techniques for Dynamically Establishing and Managing Trust Relationships”). These applications are also commonly assigned to Novell, Inc. of Provo, Utah and the disclosures of which are incorporated by reference herein.

As used herein “content” may be used interchangeably and synonymously with “document.” Content can include text, video, images, and/or audio; or various combinations of these things. Content is created or adopted by an author. Content may also be viewed as a type of resource.

A “policy” is one or more normalized instructions that can include conditions, which can be interpreted as directives that a service enforces. “Access rights” include security roles, restrictions, and/or permissions for a given resource, such as content. “Declarations” are statements that include conditions, which when evaluated (similar to policy) conditionally and dynamically resolve specific access rights for a given resource. So, access rights can be expressed as one or more declarations.

An “environment” refers to a logical processing environment for a set of resources. An example environment is a local area network (LAN) although it is to be understood that the environment can span a wide area network (WAN) and be a virtual LAN.

Various embodiments of this invention can be implemented in proxy services, directory services, security services, operating system services, and/or identity management services distributed by Novell, Inc. of Provo, Utah.

Of course, the embodiments of the invention can be implemented in a variety of architectural platforms, applications, file systems, operating and server systems, and/or devices. Any particular architectural layout or implementation presented herein is provided for purposes of illustration and comprehension only and is not intended to limit aspects of the invention.

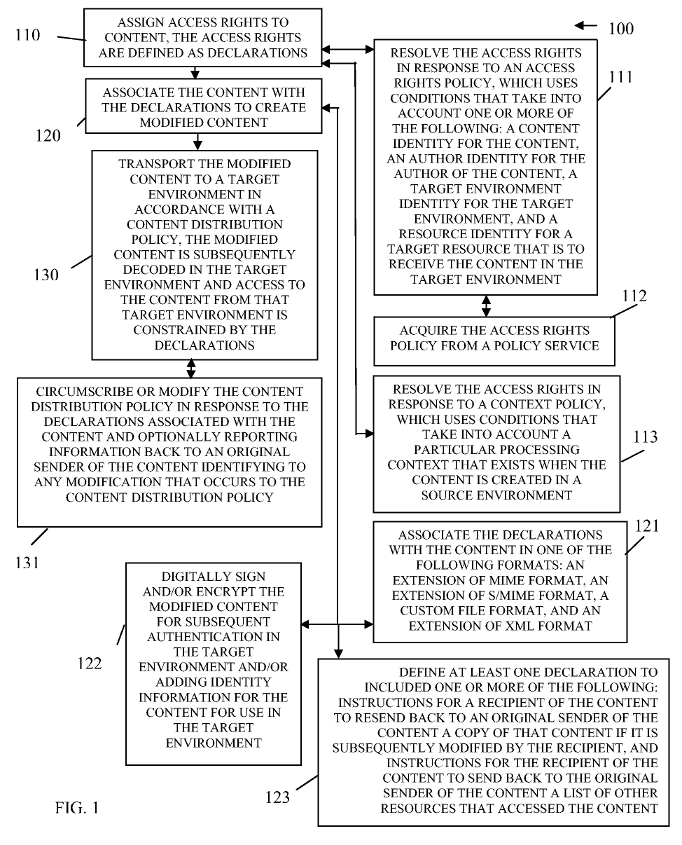

It is within this context that embodiments of the invention are now discussed with reference to the FIGS. 1-4.

FIG. 1 is a diagram of a method 100 for interoperable rights management, according to an example embodiment. The method 100 (hereinafter “content package service”) is implemented in a machine-accessible and readable medium. The content package service is operable over a network, and the network may be wired, wireless, or a combination of wired and wireless.

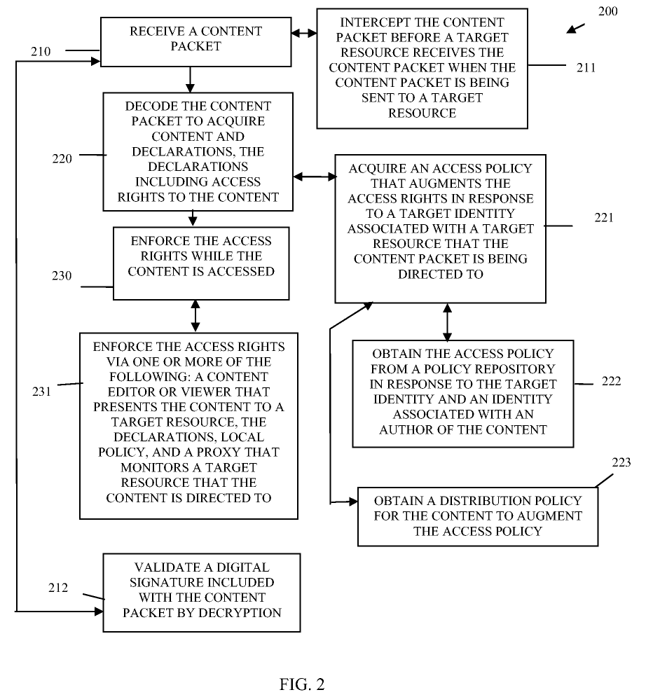

The processing depicted in the FIG. 1 with respect to the content package service represents a technique for packaging content that is edited or authored in a source environment. The processing discussed below with respect to the FIG. 2 represents a technique for enforcing access rights and policy in a target environment when the content is accessed.

It is to be noted, that once the content is accessed it can (when permitted by policy and access rights) altered or collaborated on and then redistributed over the network to yet another target environment and when this occurs the entity changing the content becomes the author and utilizes the processing associated with the FIG. 1. So, the processing associated with the FIG. 1 and the FIG. 2 can exist and be operational in each and every environment where the content is authored, viewed, received, and distributed.

At 110, the content package service assigns access rights to content. The access rights are expressed as declarations. That is, expressed as conditional statements that can be dynamically evaluated for purposes of assigning security restrictions and roles to resources that access the content.

According to an embodiment, at 111, the content package service resolves the initial access rights after obtaining and dynamically evaluating an access rights policy. The access rights policy uses conditions that take into account one or more of the following: a content identity assigned to the content, an author identity assigned to the resource that authored the content or edited the content, a target environment identity for the target environment that the content is to be sent to, and/or a target resource identity for a target resource that is to subsequently receive and perhaps collaborate on the content in the target environment.

In some cases, at 112, the access rights policy is acquired from a policy service. In a particular case, this can be an identity service that is modified to also distribute policy. Example identity services were presented above and incorporated by reference herein.

In another situation, at 113, the content package service is resolved in response to a context policy. The context policy uses conditions that take into account a particular processing context that exists when the content is created from a source environment (the environment of the author or editor of the content).

So, the policy may be explicitly obtained via external services, such as the identity service, or the policy may be implicitly obtained and resolved based on a particular operational process within which the content is being created or edited.

At 120, the content package service associates the content with the declarations to create a modified version of the content or a content package (discussed below). In this manner, the declarations having the conditionally expressed access rights defined are coupled with and included with the content before the content is injected into the network for subsequent viewing and/or collaboration. The declarations can also be part of a separate file such as, but not limited to Multipurpose Internet Mail Extensions (MIME), and the like. They can also be encoded into the actual file.

According to an embodiment, at 121, the content and declarations are associated together within a variety of formats that are extended in accordance with this particular embodiment to accommodate a content package that includes declarations for access rights along with content. Some example formats include, but are not limited to: Multipurpose Internet Mail Extension (MIME) format, Secure MIME (S/MIME) format, a custom file format, and/or Extensible Markup Language (XML) format, and/or others as well.

These extended formats facilitate the interoperability of rights enforcement for content throughout the network, such as the Internet, because existing legacy applications and systems are already equipped to recognize and process these formats. The legacy applications and systems do not necessarily have to be modified to process the extended formats either, since proxies can implement the techniques presented herein and intercept the content and process it in the manners discussed herein and below. In fact, the legacy application and systems may not even be aware of the processing discussed herein. It is noted, however, that applications and systems can be enhanced to recognize and process the techniques discussed herein in other embodiments of the invention.

In another embodiment, at 122, the content package service digitally signs the modified content and/or encrypts the modified content. This is done so that the content package can be subsequently authenticated within the target environment that it is to be delivered to. Encryption can be used via one or more public keys of the target environment where the public keys are stored in a secure location by the sender, perhaps in certificate form (where the public key is used to encrypt a one-time symmetric key with which the content is actually encrypted). Another form of encryption can use just a symmetric key that has been pre-shared and configured with the target environment and is also stored in a secure location. In either encryption scenario, a key management service can be consulted to retrieve the needed encryption keys.

In addition, with the embodiment at 122 the content package service can also add identity information for the content to the modified content for subsequent use in the target environment.

It is noted that with the embodiment at 122 a digital signature can be added to the modified content, encryption can occur to the modified content, identity information can be added for the content to the modified content, and/or various combinations of these things can occur.

In another case, at 123, the content package service defines at least one declaration to included one or more of the following: instructions for a recipient of the content to resend back to an original sender of the content a copy of that content if it is subsequently modified by the recipient, and instructions for the recipient of the content to send back to the original sender of the content a list of other resources that accessed the content.

At 130, the content package service transports the modified content to a target environment. This transportation of the modified content over the network is done in accordance with a content distribution policy. So, the access rights can be decoupled and yet tied to the particular distribution mechanism via a separate distribution policy that the content package service enforces when the modified content is injected into the network for delivery to the target environment.

The content is subsequently decoded within the target environment to separate and associated the content with the declarations (having the access rights). Access within that target environment is constrained by the declarations and in some policies local policy in the target environment.

According to an embodiment, at 131, the content package service also circumscribes or modifies the content distribution policy in response to the actual declarations included with the modified content. So, the distribution content can be dynamically altered or adjusted based on the declarations. This may include identifying or embedding some of the content distribution policies with the modified content for subsequent evaluation and enforcement within the target environment. Conversely, the declarations can be modified in response to the distribution policy. A hierarchy of priority can be established and enforced so that in some cases based on identity the content distribution policy is altered in response to the declarations or so that in some cases based on identity the declarations are altered in response to the content distribution policy.

The content package service can also optionally report information back to an original sender of the content identifying to any modification that occurs to the content distribution policy.

An example and useful declaration in a particular scenario can be defined as “if the information (content) is changed, return a copy to the original sender.” Here, such a declaration provides additional communication between a recipient and the original sender. In a similar manner, the sender can ask via a declaration that the receiver return a list of people who accessed the content as a form of auditing that the sender desires on the content.

FIG. 2 is a diagram of another method 200 for interoperable rights management, according to an example embodiment. The method 200 (hereinafter “content enforcement service”) is implemented in a machine-accessible and readable medium. The content enforcement service is operational over a network and the network may be wired, wireless, or a combination of wired and wireless.

Again, the content package service of the FIG. 1 is used when content is altered or created whereas the content enforcement service is used when the content is received at a target environment and accessed by a target resource (user or automated application). Both the content package service and the content enforcement service are operational at the same time in the same processing environment.

At 210, the content enforcement service receives a content packet or package (“packet” and “package” may be used interchangeably and synonymously herein). This can occur in a variety of manners.

For example, at 211, the content enforcement service intercepts the content packet before a target resource that is to receive the content packet is able to acquire the content packet. This can occur when the content enforcement service processes as a reverse proxy within the processing environment of the target resource that is to receive the content packet.

In another case, the content enforcement service receives the content packet from within or from communication that emanates from a content viewer or editor that is modified to recognize a content packet. So, a native document editor may be enhanced to recognize the content packet and when it does it calls the processing that invokes the content enforcement service for assistance. The actual instructions for the processing of the content enforcement service can reside within an enhanced version of the document editor or can be entirely external to the document editor.

In still another embodiment, at 212, the content enforcement service validates a digital signature included with the content packet. This can be done to ensure that no modifications have occurred with the content or content packet as a whole when it was in transport to the target environment that the content enforcement service operates within. This can also entail decrypting the signature from the content packet.

At 220, the content enforcement service decodes the content packet to acquire content and declarations. Again, the declarations include access rights for accessing the content that are conditionally expressed in statements that are capable of being dynamically interpreted and enforced by the content enforcement service when the content is accessed.

According to an embodiment, at 221, the content enforcement service acquires an access policy that augments the access rights of the declarations. This is done in response to a target identity associated with a target resource that the content packet is being delivered or directed to. The access policy may be viewed as a local policy that is locally enforced within the target environment. Moreover, it is noted that the changes or augmentations can be achieved via the local policy based on other factors, such as processing conditions within the target environment, etc.

Continuing with the embodiment of 221 and at 222, the content enforcement service obtains the access policy from a policy repository in response to the target identity and perhaps an identity associated with an author or editor of the content.

In another case associated with the embodiment of 221 and 222 at 223, the content enforcement service obtains a distribution policy for the content to augment the access policy. That is, the original distribution policy that was used in transporting the content packet from a source environment can be consulted or acquired either from the content packet or via a third-party service, such as an identity service.

At 230, the content enforcement service enforces the access rights defined in the declarations and in accordance with the declarations while the content is accessed within the target environment.

Again, in the embodiment shown at 231, the content enforcement service can actually enforce the access rights via a content editor or viewer that presents the content to a target resource and/or via a proxy (such as a reverse proxy) that monitors a target resource, which the content is directed to. The access rights can also be enforced via local policy or the declarations.

Once the content is altered or rights associated with the content are changed, the processing depicted in the method 100 of the FIG. 1 can be automatically triggered. Thus, the processing of the methods 100 and 200 cooperate with one another and act in concert with one another in some instances.

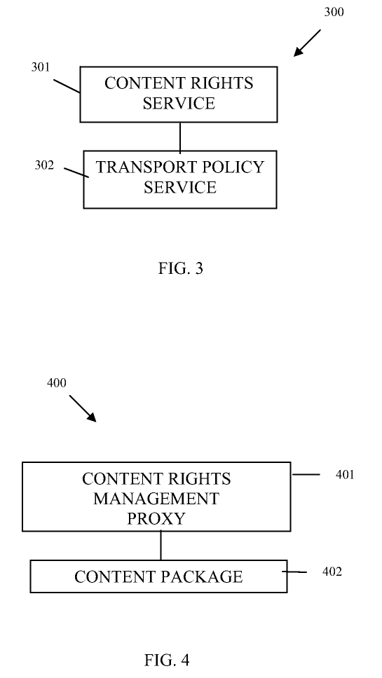

FIG. 3 is a diagram of an interoperable rights management system 300, according to an example embodiment. The interoperable rights management system 300 is implemented in a machine-accessible and computer-readable storage medium and processes as instructions on one or more machines (computer or processor enabled device) over a network. The network may be wired, wireless, or a combination of wired and wireless. In an embodiment, the interoperable rights management system 300 implements among other things the content package service represented by the method 100 of FIG. 1.

The interoperable rights management system 300 includes a content rights service 301 and a transport policy service 302. Each of these will now be discussed in turn.

The content rights service 301 is implemented in a computer-readable storage medium as instructions that process on one or more machines of the network. Example processing associated with the content rights service 301 was presented in detail above with respect to the content package service represented by the method 100 of the FIG. 1.

The content rights service 301 packages the content with declarations that define access rights to a piece of content.

According to an embodiment, the content rights service 301 acquires the declarations in response to an access rights policy, which is obtained in response to identities assigned to the author, the content, a target resource that collaborates on the content, and/or identities associated with the source and target environments of the content.

In another instance, the content rights service 301 digitally signs the packaged content before handing the packaged content over to the transport policy service 302 and encrypts the signature and/or packaged content in some instances.

The transport policy service 302 is implemented in a computer-readable storage medium as instructions that process on one or more machines of the network. Example processing associated with the transport service 302 was presented above with reference to the method 100 of the FIG. 1.

The transport policy service 302 injects the packaged content into the network for delivery to a target environment. This delivery or injection procedure is constrained and done in accordance with a distribution policy.

According to an embodiment, the transport policy service 302 acquires the distribution policy in response to the declarations that the content rights service 301 assigned to the piece of content when forming the packaged content. Here, also credentials for the packaged content are identified; such credentials were packed via the content rights service 301 with the packaged content.

In an embodiment, the transport policy service 302 dynamically interacts with an identity service to acquire a unique identity and credentials for the packaged content before the packaged content is injected into the network in accordance with the distribution policy. So, the transport policy service 302 can verify the acquired identity and acquired credentials against the other credentials that the content rights service 301 included with the packaged content (as discussed immediately above). The transport policy service 302 can also sign and/or encrypt the content as well before delivery to a target recipient of the target environment.

Services of the target environment can then verify the identity of the packaged content via the same identity service or via another identity service that is in a trusted communication relationship with the identity service that initially supplied the identity and credentials for the packaged content.

In some cases, the transport policy service 302 can also send the entire packaged content back to the original sender or sending application for that sender or sending application to forward on to the target recipient or resource in the target environment.

FIG. 4 is a diagram of another interoperable rights management system 400, according to an example embodiment. The interoperable rights management system 400 is implemented in a machine-accessible and computer-readable storage medium as instructions that process on one or more machines (computer or processor-enabled device) of a network. The network may be wired, wireless, or a combination of wired and wireless. In an embodiment, the interoperable rights management system 400 implements, among other things, the processing associated with the content enforcement service represented by the method 200 of the FIG. 2.

The interoperable rights management system 400 includes a contents rights management proxy 401 and a content package 402. Each of these will now be discussed in turn.

The content rights management proxy 401 is implemented as a logical or physical machine having a variety of instructions within a computer-readable storage medium. The instructions are processed by one or more physical machines of the network. Some aspects of the content rights management proxy 401 were presented above with reference to the content enforcement service represented by the method 200 of the FIG. 2.

The content rights management proxy 401 receives the content package 402 and parses the content package 402 for content and declarations. Again, the declarations are conditional access rights assignment statements for the content. The content rights management proxy 401 then enforces the access rights defined in the declarations when the content is accessed by a target resource.

According to an embodiment, the content rights management proxy 401 acquires an access policy that augments or alters enforcement of the access rights for the content. This may entail acquiring a local policy as the access policy that expands and/or restricts access for the content for defined security and/or processing conditions or circumstances.

In another scenario, the content rights management proxy 401 acquires a distribution policy that augments or modifies enforcement of the access policy and/or the access rights. So, the distribution policy can be enhanced to include additional limitations or rights and that decision and action can be done by the content rights management proxy 401 based on a variety of factors such as identities of the resources, conditions in the processing environment, policies, etc.

In a particular situation, the content rights management proxy 401 enforces the access rights in view of an identity associated with an author or editor of the content and/or an identity associated with the target resource.

Also, the content rights management proxy 401 can decrypt and/or validate a signature for the content package 402 before the content is accessed by a target recipient in the target environment. Thereafter, the content may be subsequently kept in clear text, signed only, or in encrypted and signed formats for future access by a target recipient in the target environment. In some cases, an identity service can be used to assist in verifying the digital signature. In other cases, a key management service could be used to assist in decrypting the content.

The content package 402 is implemented in a computer-readable storage medium and is processed and managed by the content rights management proxy 401.

The content package 402 is created by the method 100 of the FIG. 1 and/or the system 300 of the FIG. 3. The content package 402 includes declarations and content. In some cases, the content package 402 can include a variety of other information, such as a digital signature for the content, the distribution policy or an entity that can supply the original distribution policy used for delivering the content package 402 over the network to the target environment, and the like. The content package 402 can be encrypted. The content package 402 can also be encoded in extended versions of MIME, S/MIME, XML, etc.

In still another situation, the content rights proxy 401 reports information back to a source of a content associated with the content package including a copy of modified content when the content was modified and/or reports information back to a source of the content identifying a list of resources that have accessed the content in a target environment of the target resource.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
assigning access rights to content, wherein the access rights are defined as declarations;
associating the content with the declarations to create modified content; and
transporting the modified content to a target environment in accordance with a content distribution policy, wherein the modified content is subsequently decoded in the target environment and access to the content from that target environment is constrained by the declarations.

2. The method of claim 1, wherein assigning further includes resolving the access rights in response to an access rights policy, which uses conditions that take into account one or more of the following: a content identity for the content, an author identity for the author of the content, a target environment identity for the target environment, and a resource identity for a target resource that is to receive the content in the target environment.

3. The method of claim 2, wherein resolving further includes acquiring the access rights policy from a policy service.

4. The method of claim 1, wherein assigning further includes resolving the access rights in response to a context policy, which uses conditions that take into account a particular processing context that exists when the content is created in a source environment.

5. The method of claim 1, wherein associating further includes encoding the declarations with the content in one of the following formats: an extension of Multipurpose Internet Mail Extension format (MIME), an extension of Secure MIME (S/MIME) format, a custom file, and an extension of Extensible Markup Language (XML) format.

6. The method of claim 1, wherein associating further includes digitally signing, encrypting the modified content, and/or adding identity information for the modified content for subsequent authentication and use within the target environment.

7. The method of claim 1, wherein associating further includes defining at least one declaration to included one or more of the following: instructions for a recipient of the content to resend back to an original sender of the content a copy of that content if it is subsequently modified by the recipient, and instructions for the recipient of the content to send back to the original sender of the content a list of other resources that accessed the content.

8. The method of claim 1, wherein transporting further includes circumscribing or modifying the content distribution policy in response to the declarations associated with the content and optionally reporting information back to an original sender of the content identifying to any modification that occurs to the content distribution policy.

9. A machine-implemented method, comprising:
receiving a content packet;
decoding the content packet to acquire content and declarations, the declarations including access rights; and
enforcing the access rights while the content is accessed.

10. The method of claim 9, wherein receiving further includes intercepting the content packet before a target resource receives the content packet when the content packet is being sent to a target resource.

11. The method of claim 9, wherein decoding further includes acquiring an access policy that augments the access rights in response to a target identity associated with a target resource that the content packet is being directed to, wherein the access policy is a local applied policy acquired for the target environment.

12. The method of claim 11, wherein acquiring further includes obtaining the access policy from a policy repository in response to the target identity and an identity associated with an author of the content.

13. The method of claim 11, wherein acquiring further includes obtaining a distribution policy for the content to augment the access policy.

14. The method of claim 9, wherein receiving further includes decrypting all or part of the content package and/or validating a digital signature included with the content packet.

15. The method of claim 9, wherein enforcing further includes enforcing the access rights via one or more of the following: a content editor or viewer that presents the content to a target resource, the declarations, local policy, and a proxy that monitors a target resource that the content is directed to.

16. A machine-implemented system, comprising:
a content rights service implemented in a computer-readable storage medium and to process on a network; and
a transport policy service implemented in a computer-readable storage medium and to process on the network;
wherein the content rights service is to package content with declarations defining access rights to a piece of content, and wherein the transport policy service is to inject the packaged content into the network for delivery to a target environment in accordance with a distribution policy.

17. The system of claim 16, wherein the contents rights service is to acquire the declarations in response to an access rights policy.

18. The system of claim 16, wherein the transport policy service is to acquire the distribution policy in response to the declarations.

19. The system of claim 16, wherein the contents rights service encrypts some or all of the packaged content and/or digitally signs the packaged content before handing the packaged content over to the transport policy service.

20. The system of claim 16, wherein the transport policy service interacts with an identity service to acquire a unique identity and credentials for the packaged content before injecting it into the network, where other credentials being compared against the acquired identity and the acquired credentials are packaged with the packaged content by the content rights service and/or wherein the transport policy service encrypts and/or digitally signs some or all of the packaged content before injecting it into a network.

21. The system of claim 20, wherein the target environment verifies the identity of the packaged content via an identity service.

22. A machine-implemented system comprising:
a content rights management proxy implemented in a computer-readable storage medium and to process on a network; and
a content package implemented in a computer-readable storage medium and processed by the content rights management proxy;
wherein the content rights management proxy receives the content package and parses the content package for content and declarations, the declaration including access rights to the content, and wherein the content rights management proxy enforces the access rights when the content is accessed by a target resource.

23. The system of claim 22, wherein the content rights management proxy acquires an access policy that augments, enhances, or alters, enforcement of the access rights.

24. The system of claim 23, wherein the contents rights management proxy acquires a distribution policy that augments or modifies enforcement of the access policy and the access rights.

25. The system of claim 22, wherein the contents rights management proxy enforces the access rights in view of an identity associated with an author of the content and an identity associated with the target resource.

26. The system of claim 25, wherein the content rights proxy decrypts some or all of the content package and/or validates a digital signature for some or all of the content package prior to content associated with the content package being accessed by the target resource.

27. The system of claim 22, wherein the content rights proxy reports information back to a source of a content associated with the content package including a copy of modified content when the content was modified and/or reports information back to a source of the content identifying a list of resources that have accessed the content in a target environment of the target resource.
